(19) United States
(12) Patent Application Publication
(10) Pub. No.: US 2007/0250845 A1
(43) Pub. Date: Oct. 25, 2007

(54) System and method of delivering calls

(75) Inventors: Edward Walter, Boerne, TX (US); Robert R. Popp JR., New Braunfels, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/395,742

(22) Filed: Mar. 31, 2006

(51) Int. Cl. H04N 7/173; H04N 7/18; H04H 9/00; H04N 7/16

(52) U.S. Cl. 725/10; 725/110; 725/112; 725/109; 725/80

(57) ABSTRACT

The present disclosure is directed to a system and method of delivering calls. In a particular embodiment, the method includes receiving a call at a server within an Internet Protocol Television (IPTV) system, where the call is directed to a user premise. The method also includes determining a presence of a user at a set-top box device at the user premise and determining a speed select function associated with the user. The method also includes selectively delivering the call to a communication device in proximity to the set-top box device via a private access network of the IPTV system, based on the speed select function.

### FIELD OF THE DISCLOSURE

The present disclosure relates generally to delivering calls.

### BACKGROUND

Television viewing is part of daily life. Many individuals prefer not be interrupted while watching television, but they may desire to monitor telephone calls, for example, in case of an emergency or to avoid reviewing a large number of new messages at a future time. Technical compatibilities pose challenges when integrating conventional telephone and television networks, in addition to data networks, such as the Internet or wireless networks.

Certain systems that allow a user to access a store of messages from a television do not provide notifications of communications as they occur. Moreover, these systems do not allow a user to select which handsets or rooms in their homes to ring when they are watching television, and the user is disturbed by incoming calls. Hence, there is a need for an improved system and method of delivering calls.

### BRIEF DESCRIPTION OF THE DRAWINGS

FIG. 1 is a block diagram illustrating an embodiment of an Internet Protocol Television (IPTV) system;

FIG. 2 is a flow diagram illustrating a particular embodiment of a method of configuring call delivery;

FIG. 3 is a flow diagram illustrating a particular embodiment of a method of delivering calls;

FIG. 4 is a flow diagram illustrating a second particular embodiment of a method of receiving calls;

FIG. 5 is diagram of an illustrative embodiment of a graphical user interface to receive calls;

FIG. 6 is a diagram of a second illustrative embodiment of a graphical user interface to receive calls;

FIG. 7 is a diagram of an illustrative embodiment of a graphical user interface to configure call delivery;

FIG. 8 is a diagram of a second illustrative embodiment of a graphical user interface to configure call delivery;

FIG. 9 is a diagram of a third illustrative embodiment of a graphical user interface to configure call delivery;

FIG. 10 is a diagram of a fourth illustrative embodiment of a graphical user interface to configure call delivery; and

FIG. 11 is a diagram of an embodiment of a general computer system.

### DETAILED DESCRIPTION OF THE DRAWINGS

A system to deliver calls is disclosed and includes a communication server within an Internet Protocol Television (IPTV) system, where the communication server is configured to receive a call. The communication server is configured to determine a presence of a user at a set-top box device at a user premise and to determine a speed select function associated with the user. Further, the communication server is configured to selectively deliver the call to a phone in proximity to the set-top box device based on the speed select function.

In another embodiment, a method of delivering calls is disclosed and includes receiving a call at a server within an Internet Protocol Television (IPTV) system, where the call is directed to a user premise. The method also includes determining a presence of a user at a set-top box device at the user premise and determining a speed select function associated with the user. The method also includes selectively delivering the call to a communication device in proximity to the set-top box device via a private access network of the IPTV system, based on the speed select function.

In another embodiment, a method of receiving calls is disclosed and includes prompting a user to input a selection of a user profile during activation of a set-top box device and communicating the user profile to a server of an Internet Protocol Television (IPTV) system, where the server selectively delivers calls to a phone in proximity to the set-top box device based on a speed select function associated with the user profile.

In another embodiment, a computer program embedded in a computer-readable medium is disclosed and includes instructions to communicate with at least one communication network to receive a call directed to a user premise. The computer program also includes instructions to determine a presence of a user at a set-top box device at the user premise and to determine a speed select function associated with the user. The computer program also includes instructions to selectively deliver the call to a communication device in proximity to the set-top box device based on the speed select function.

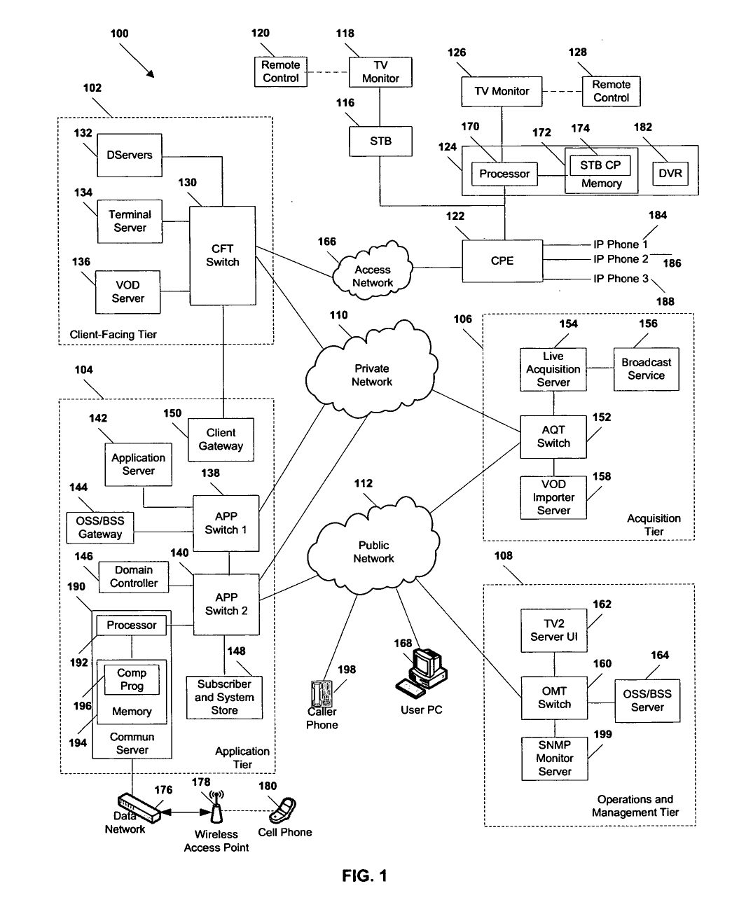

Referring to FIG. 1, an illustrative embodiment of an Internet Protocol Television (IPTV) system that may be used to deliver calls is illustrated and is generally designated 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

The client-facing tier 102 can communicate with user equipment via an access network 166, such as an Internet Protocol Television (IPTV) access network. In an illustrative embodiment, customer premises equipment (CPE) 122 can be coupled to the access network 166. The client-facing tier 102 can communicate with a first representative set-top box device 116 at a customer premise via the CPE 122 and with a second representative set-top box device 124 at the customer premise via the CPE 122. The CPE 122 can include routers, local area network devices, modems, such as digital subscriber line (DSL) modems, any other suitable devices for facilitating communication between a set-top box device and the access network 166, or any combination thereof. The client-facing tier 102 can communicate with a large number of set-top boxes, such as the representative set-top boxes 116, 124, over a wide geographic area, such as a regional area, a metropolitan area, a viewing area, a designated market area or any other suitable geographic area, market area, or subscriber or customer group that can be supported by networking the client-facing tier 102 to numerous set-top box devices. In an illustrative embodiment, the client-facing tier 102, or any portion thereof, can be included at a video head-end office.

In a particular embodiment, the client-facing tier 102 can be coupled to the CPE 122 via fiber optic cables. Alternatively, the CPE 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Microsoft® TV IPTV Edition.

Additionally, the first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device 124 can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive data or video from the client-facing tier 102 via the private access network 166 and render or display the data or video at the display device 118, 126 to which it is coupled. In an illustrative embodiment, the set-top box devices 116, 124 can include tuners that receive and decode television programming information for transmission to the display devices 118, 126. Further, the set-top box devices 116, 124 can include a STB processor 170 and a STB memory device 172 that is accessible to the STB processor 170. In one embodiment, a computer program, such as the STB computer program 174, can be embedded within the STB memory device 172. Each set-top box device 116, 124 can also include an internal video content storage device, such as a digital video recorder 182.

In an illustrative embodiment, the client-facing tier 102 can include a client-facing tier (CFT) switch 130 that manages communication between the client-facing tier 102 and the access network 166 and between the client-facing tier 102 and the private network 110. As shown, the CFT switch 130 is coupled to one or more data servers, such as D-servers 132, that store, format, encode, replicate, or otherwise manipulate or prepare video content for communication from the IPTV system 100 to the set-top box devices 116, 124. The CFT switch 130 can also be coupled to a terminal server 134 that provides terminal devices with a connection point to the private network 110. In a particular embodiment, the CFT switch 130 can also be coupled to a video-on-demand (VOD) server 136 that stores or provides VOD content imported by the IPTV system 100.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the access network 166, which enable the set-top box devices 116, 124 to provide functions, such as display, messaging, processing of IPTV data and VOD material, etc. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server 164 that stores operations and billing systems data.

Further, the second APP switch 140 can be coupled to a domain controller 146 that provides Internet access, for example, to users via the public network 112. For example, the domain controller 146 can provide remote Internet access to IPTV account information, e-mail, personalized Internet services, or other online services via the public network 112. Users can access such information or services using, for example, their personal computers 168. The second APP switch 140 can be coupled to a subscriber and system store 148 that includes account information, such as account information that is associated with users who access the system 100 via the private network 110 or the public network 112.

In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto. In an illustrative embodiment, the set-top box devices 116, 124 can access the IPTV system 100 via the access network 166, using information received from the client gateway 150. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the system 100 via the access network 166, the client gateway 150 can verify subscriber information by communicating with the subscriber and system store 148 via the private network 110, the first APP switch 138, and the second APP switch 140. Further, the client gateway 150 can verify billing information and status by communicating with the OSS/BSS gateway 144 via the private network 110 and the first APP switch 138. In one embodiment, the OSS/BSS gateway 144 can transmit a query via the first APP switch 138, to the second APP switch 140, and the second APP switch 140 can communicate the query via the public network 112 to the OSS/BSS server 164. After the client gateway 150 confirms subscriber and/or billing information, the client gateway 150 can allow the set-top box device 116 to access IPTV content and VOD content. If the client gateway 150 cannot verify subscriber information for the set-top box device 116, e.g., because it is connected to an unauthorized twisted pair, the client gateway 150 can block transmissions to and from the set-top box device 116 beyond the access network 166.

Additionally, the second APP switch 140 can be coupled to a communication server 190. The communication server 190 includes a processor 192 and a memory portion 194 accessible to the processor 192. The communication server 190 also includes a computer program 196 embedded in the memory portion 194. In a particular embodiment, the communication server 190 communicates with one or more telephone networks, such as a Voice-over IP network, a Public Switched Telephone Network (PSTN), a cellular network, or any combination thereof, and receives calls from caller phones 198. The communication server 190 delivers the calls to user Internet Protocol (IP) phones 184-188 via the access network 166 and CPE 122. In an illustrative embodiment, the communication server 190 can also receive calls from cellular phones 180 via a data network 176 that communicates with a wireless access point 178. Further, the communication server 190 can receive voice mail messages from caller phones 198 via the public network 112. The communication server 190 can store the voice mail messages after associating them with user accounts, or the communication server 190 can transmit the voice mail messages to the subscriber and system store 148 for storage. In a particular embodiment, the communication server 190 generates notifications of calls and voice mails and transmits the notifications to set-top box devices 116, 124 over the private access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television or movie content, for example, from a broadcast service 156. In a particular embodiment, the live acquisition server 154 can transmit the television or movie content to the AQT switch 152, and the AQT switch 152 can transmit the television or movie content to the CFT switch 130 via the private network 110.

In an illustrative embodiment, the television or movie content can be transmitted to the D-servers 132, where it can be encoded, formatted, stored, replicated, or otherwise manipulated and prepared for communication to the set-top box devices 116, 124. The CFT switch 130 can receive the television or movie content from the D-servers 132 and communicate the content to the CPE 122 via the access network 166. The set-top box devices 116, 124 can receive the television or movie content via the CPE 122, and can transmit the television or movie content to the television monitors 118, 126. In an illustrative embodiment, video or audio portions of the television or movie content can be streamed to the set-top box devices 116, 124.

Further, the AQT switch can be coupled to a video-on-demand importer server 158 that stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116, 124, the requests can be transmitted over the access network 166 to the VOD server 136, via the CFT switch 130. Upon receiving such requests, the VOD server 136 can retrieve the requested VOD content and transmit the content to the set-top box devices 116,124 across the access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 199 that monitors network devices within or coupled to the IPTV system 100. In a particular embodiment, the OMT switch 160 can communicate with the AQT switch 152 via the public network 112.

In an illustrative embodiment, the live acquisition server 154 can transmit the television or movie content to the AQT switch 152, and the AQT switch 152, in turn, can transmit the television or movie content to the OMT switch 160 via the public network 112. In this embodiment, the OMT switch 160 can transmit the television or movie content to the TV2 server 162 for display to users accessing the user interface at the TV2 server 162. For example, a user can access the TV2 server 162 using a personal computer (PC) 168 coupled to the public network 112.

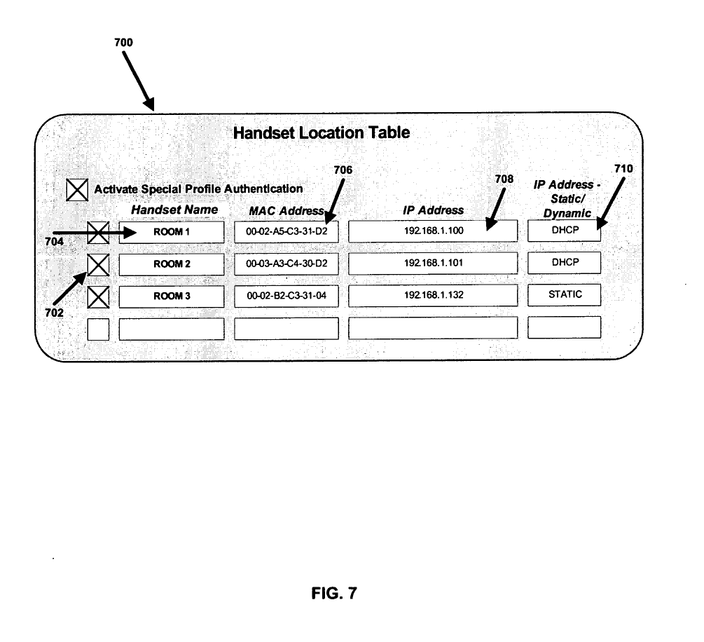

In a particular embodiment, a user configures handset locations within a user premise, such as locations of the user IP phones 184-188. In an illustrative embodiment, the user can access a handset location table by using a set-top box device 116, 124 to request a handset location table from an application server 142 or other server of the Internet Protocol Television (IPTV) system 100. Alternatively, the user can access the handset location table by using the personal computer 168 to access the domain controller 146 or other server of the IPTV system 100. An example of a handset location table is illustrated in FIG. 7. The user can configure locations of handsets in a plurality of rooms, for example, by inputting IP addresses, Media Access Control (MAC) addresses, other data related to the user IP phones 184-188, or any combination thereof, into the handset location table. The handset location table can be stored at the application server 142, communication server 190, subscriber and system store 148, or other server of the IPTV system 100.

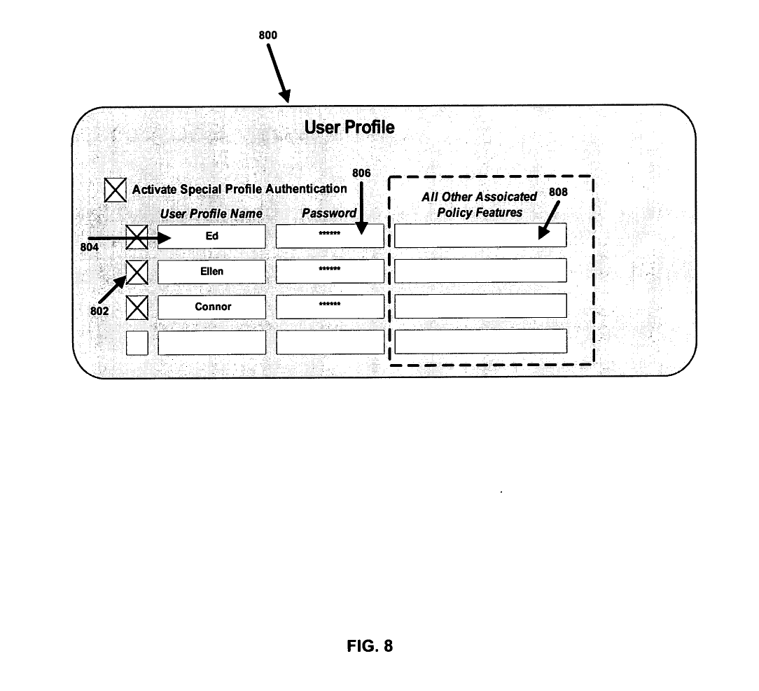

Further, the user can configure user profiles. In an illustrative embodiment, the user can configure user profiles by inputting user names, passwords, access policies, other data related to users, or any combination thereof, into a user profile user interface that the user accesses via the set-top box device 116, 124 or personal computer 168. The user profiles can be stored at the application server 142, subscriber and system store 148, communication server 190, or other server of the IPTV system 100. An example of a user profile user interface is illustrated in FIG. 8.

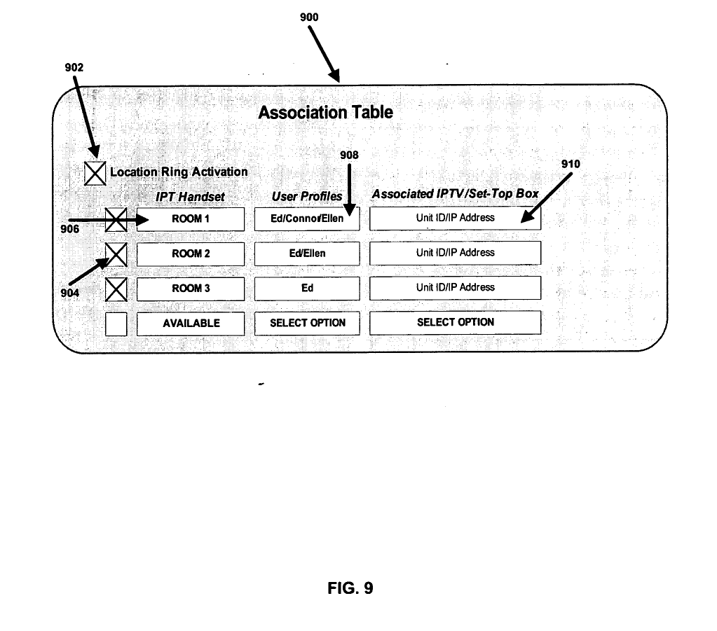

In a particular embodiment, the user can configure associations among rooms, handsets, user profiles, set-top box devices, or any combination thereof. For instance, the user can associate one or more users with each user IP phone 184-188 configured in the handset location table. Further, the user can associate the one or more users with a unit number, IP address, or other identifier of a set-top box device 116, 124 that is in the room or other proximity of the user IP phone 184-188. The user can configure associations by accessing an association table at the application server 142 or other server of the IPTV system 100, such as the association table illustrated in FIG. 9. The associations can be stored at the application server 142, subscriber and system store 148, communication server 190, or other server of the IPTV system 100.

In addition, the user can configure speed select functions. Speed select functions can include call delivery instructions or rules related to user profiles, user IP phones 184-188, set-top boxes 116, 124, or any combination thereof. For example, a first speed select function can indicate that calls should not ring at a first user IP phone 184, when a first user is using a set-top box device 116 associated with the first user IP phone 184. Another speed select function can indicate that calls should ring at a second user IP phone 186, when a second user is using a set-top box 124 associated with the second user IP phone 186. In another embodiment, a third speed select function can indicate that all calls should be forwarded to voice mail or another phone when a set-top box 124 associated with the second user IP phone 186 is being used by a third user. Further, a fourth speed select function can indicate that a user interface allowing a user to select a speed select function should be presented at a set-top box associated with a third user IP phone 188 when the third user is using the set-top box device. A speed select function can be configured and associated with each user profile. Alternatively, a user can select a speed select function upon request or each time a set-top box 116, 124 is activated.

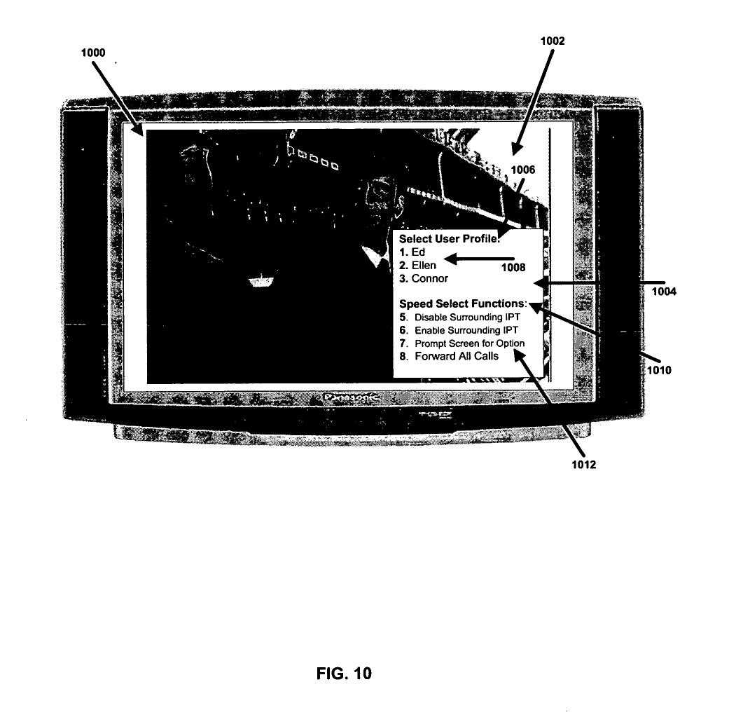

In an illustrative embodiment, a user can activate a set-top box device and request video content to be displayed at a display device coupled to the set-top box device, such as the second representative set-top box device 124. The set-top box device 124 can transmit a prompt to the television monitor 126 requesting that the user enter a user profile selection. In a particular embodiment, the user can also enter a speed select function. An example of a prompt to enter a user profile selection and speed select function is illustrated in FIG. 10. The set-top box device can also prompt the user to enter a password associated with the selected user profile. Alternatively, the set-top box device can receive prompts for a user profile, speed select function, password, or any combination thereof, from the application server 142 or other server of the IPTV system 100 when the set-top box device 124 is activated. The set-top box device can transmit the user profile selection, speed select function, password, or any combination thereof, to the application server 142, subscriber and system store 148, communication server 190, or other server of the IPTV system 100.

In a particular embodiment, the communication server 190 can receive a call from the caller phone 198 via the public network 112. The communication server 190 can identify a destination of the call, for example, by querying the subscriber and system store 148 for account information corresponding to a destination telephone number. In an illustrative embodiment, the communication server 190 can determine whether one or more of the set-top box devices 116, 124 at the destination is activated. If none of the set-top boxes 116, 124 is activated, the communication server 190 can ring all of the user IP phones 184-188 at the destination. Alternatively, if one or more of the set-top box devices 116, 124 is activated, the communication server 190 can determine a user profile selected at each activated set-top box device, a speed select function selected at each activated set-top box device, or any combination thereof. For example, the communication server 190 can issue a query to the application server 142, subscriber and system store 148, or other server of the IPTV system 100, to determine the user profile, speed select function, or any combination thereof, selected at each of the activated set-top box devices 116, 124.

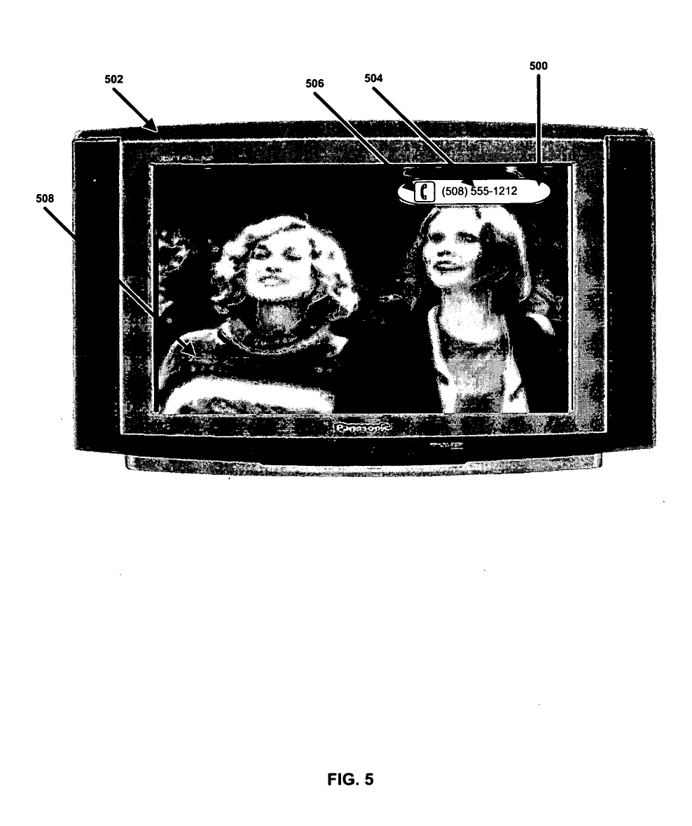

The communication server 190 can ring one or more of the user IP phones 184-188 at the customer premise based on a location ring activation table, the user profile selected at each activated set-top box device 116, 124, the speed select function selected at each activated set-top box device 116, 124, or any combination thereof. In a particular embodiment, the communication server 190 can generate a notification relating to the call and transmit the notification to the activated set-top box devices 116, 124 via the private access network 166. The set-top box device 116, 124 can transmit the notification to the television monitor 118, 126 for display. An example of a notification displayed via a television monitor is illustrated in FIG. 5. In an illustrative embodiment, the communication server 190 can transmit a copy of the notification to the subscriber and system store 148 or other server of the IPTV system 100 for storage with the user's account.

In an illustrative embodiment, if a call is not answered, the communication server 190 can receive a voice mail from the caller phone 198 via the public network 112. The communication server 190 can store the voice mail and/or the related notification or transmit the voice mail and/or notification to the subscriber and system store 148 or another server of the IPTV system 100 for storage. Further, the communication server 190 can generate a notification of the voice mail and transmit the notification to the set-top box device 116, 124 via the private access network 166 for display at the television monitor 118, 126. In a particular embodiment, the communication server 190 can receive a request to view or listen to the voice mail message from a set-top box device 116, 124 and to transmit the voice mail message to the set-top box device 116, 124. In one embodiment, the communication server 190 can transmit an audio file containing the voice mail message to the set-top box device 116, 124. Alternatively, the communication server 190 can convert the message to a text message and transmit the text message to the set-top box device 116, 124.

Call notifications and voice mail notifications can include any information suitable for notifying the user that a telephone call is being or has been issued to the user. For example, the notification can include the caller's name, the caller's telephone number, the caller's address, the destination telephone number, any portion of caller identification information received at the communication server 190, a telephone call symbol, a telephone call audio tone, a voice mail symbol, a voice mail audio tone, a date of a call, a time of a call, a date of a voice mail message, a time of a voice mail message or any combination of these.

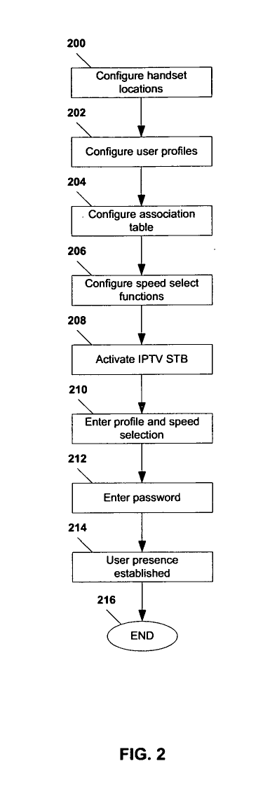

Referring to FIG. 2, a method of configuring call delivery is illustrated. A user can configure call delivery, for example, when a set-top box is first activated, when a service is first activated, by requesting a configuration user interface, or any combination thereof. At block 200, a user configures handset locations within a user premise. In an illustrative embodiment, the user can access a handset location table by using a set-top box device to request the handset location table from a server of an Internet Protocol Television (IPTV) network. Alternatively, the user can access the handset location table via a personal computer that communicates with a server of the IPTV network. An example of a handset location table is illustrated in FIG. 7. The user can configure locations of handsets in a plurality of rooms, for example, by inputting IP addresses, Media Access Control (MAC) addresses, other data related to handset locations, or any combination thereof, into the handset location table. The handset location table can be stored at the server of the IPTV network.

Moving to block 202, the user can configure user profiles. In an illustrative embodiment, the user can configure user profiles by inputting user names, passwords, access policies, other data related to users, or any combination thereof, into a user profile user interface that the user accesses via the set-top box device or personal computer. The user profiles can be stored at a server of the IPTV network. An example of a user profile user interface is illustrated in FIG. 8.

Continuing to block 204, the user configures associations among rooms, handsets, user profiles, set-top box devices, or any combination thereof. For instance, the user can associate one or more users with each room or handset configured in the handset location table. Further, the user can associate the one or more users with a unit number, IP address, or other identifier of a set-top box device that is in the room or other proximity of the handset. The user can configure associations by accessing an association table at a server of the IPTV system, such as the association table illustrated in FIG. 9. The associations can be stored at the server.

Proceeding to block 206, the user configures speed select functions. Speed select functions include call delivery instructions related to user profiles, handsets, set-top boxes, or any combination thereof. For example, a first speed select function can indicate that calls should not ring at a first handset, such as ‘ROOM 1,’ when a first user, such as ‘ELLEN’ is using a set-top box device associated with ‘ROOM 1.’ Another speed select function can indicate that calls should ring at a second handset, such as ‘ROOM 2,’ when a second user, such as ‘CONNOR’ is using a set-top box associated with ‘ROOM 2.’ In another embodiment, a third speed select function can indicate that all calls should be forwarded to voice mail or another phone when a set-top box associated with ‘ROOM 3’ is being used by a third user, such as ‘ED.’ Further, a fourth speed select function can indicate that a user interface allowing a user to select a speed select function should be presented at the set-top box associated with ROOM 1 when ‘ED’ is using the set-top box device. A speed select function can be configured and associated with each user profile. Alternatively, a user can select a speed select function upon request or each time a set-top box is activated.

In an illustrative embodiment, at block 208, a user can activate a set-top box device and request video content to be displayed at a display device coupled to the set-top box device. Moving to block 210, the user can enter a user profile selection in response to a prompt transmitted to the display device. In a particular embodiment, the user can also enter a speed select function. An example of a prompt to enter a user profile selection and speed select function is illustrated in FIG. 10. Continuing to block 212, the user can also enter a password associated with the selected user profile. Proceeding to block 214, the presence of the user is established at the set-top box device, such that call delivery instructions associated with a speed select function, user profile, or any combination thereof, can be executed. The method terminates at 216.

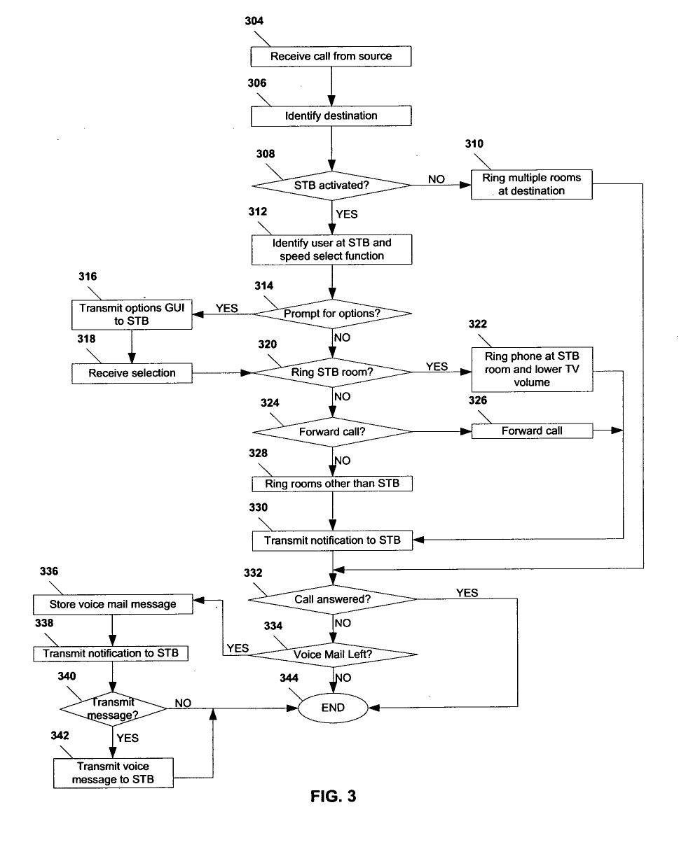

Referring to FIG. 3, a method of delivering calls is illustrated. At block 304, a call is received at a server of an Internet Protocol Television (IPTV) network. Moving to block 306, and the server identifies a destination of the call, such as a customer premise, based on a destination telephone number, for example. Continuing to decision step 308, the server can determine whether one or more set-top box devices are activated at the destination. For example, the server can determine IP addresses of set-top boxes at the destination based on account information associated with the destination telephone number. In a particular embodiment, if no set-top box devices are activated at the destination, the method proceeds to block 310, and the server can ring multiple phones, such as all phones, at the destination. The method then advances to block 332.

Returning to decision step 308, if the server determines that a set-top box device is activated, the method moves to block 312, and the server determines a user profile that was selected when the set-top box was activated. In an illustrative embodiment, the server can also determine a speed select function that was selected when the set-top box device was activated. Continuing to decision step 314, the server determines whether a prompt for a speed select function should be transmitted to the set-top box device for display at a display device coupled to the set-top box device. For example, the user could have selected ‘prompt for options’ as a speed select function when activating the set-top box device. Alternatively, the ‘prompt for options’ speed select function can be associated with the user profile selected when the set-top box device was activated.

If the server determines that no such prompt is to be presented to the user, the method proceeds to decision step 320. On the other hand, if the server determines that a prompt is to be presented to the user, the method moves to block 316, and the server can transmit a graphical user interface (GUI) or other prompt to the set-top box device. The GUI or other prompt includes selectable option indicators corresponding to various speed select functions, such as enable surrounding phone, disable surrounding phone, forward calls, other call delivery instructions, or any combination thereof. Continuing to block 318, a selection is received from the user via the GUI. The method then proceeds to decision step 320.

At decision step 320, the set-top box determines whether it is to ring a phone in proximity to the activated set-top box device, such as a handset in the same room. If the server determines that it is to ring the phone, the method moves to block 322, and the server rings the phone. In an illustrative embodiment, the server can also transmit an instruction to the set-top box device to lower the volume audio associated with video content being displayed at the display device. The method then proceeds to block 330.

Returning to decision step 320, if the server determines that it is to ring the phone in proximity to the activated set-top box device, the method continues to decision step 324. At decision step 324, the server determines whether calls to the destination are to be forwarded to voice mail or another phone, such as a cellular phone. If the server determines that calls are to be forwarded, the method moves to block 326, and the call is forwarded. The method then proceeds to block 330. Conversely, if the server determines that it is not to forward calls, the method advances to block 328, and the server rings phones in rooms other than those in proximity to the activated set-top box device. The method then proceeds to block 330.

At block 330, a telephone call notification is transmitted to the set-top box device for display via the display device. For example, the notification can include the caller's name, the caller's telephone number, the destination telephone number, any portion of caller identification information received at the server, a telephone call symbol, a telephone call audio tone, or any combination of these. The method continues to decision step 332, and the server determines whether the call is answered at its destination or forwarding location. If the call is answered, the method terminates at 344.

Alternatively, if the call is not answered, the method can proceed to decision step 334, and the server can determine whether the caller has left a voice mail message. When a voice mail message has not been left, the method terminates at 344. On the other hand, in a particular embodiment, when a voice mail message is left, the method moves to block 336, and the server can store the voice mail message. In an illustrative embodiment, the method can proceed to block 338, and a notification that a voice mail has been left can be transmitted to the activated set-top box device. The message then advances to decision step 340, and the server can determine whether the voice mail message has been requested at the set-top box device. If the voice mail message is not requested, the method terminates at 344. Conversely, if the voice mail message is requested, the server can transmit the voice mail message to the set-top box device at block 342. In one embodiment, the voice mail message can be transmitted as an audio message. In another embodiment, the server can convert the voice mail message to text that is transmitted to the set-top box device. The method terminates at 344.

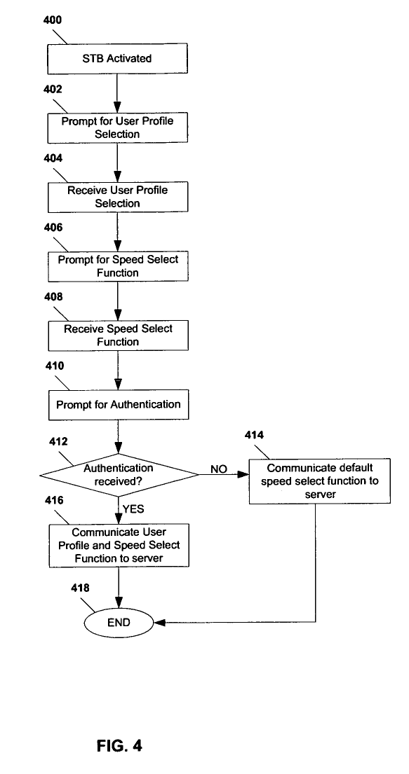

Referring to FIG. 4, a method of receiving calls is illustrated. At block 400, a set-top box device at a customer premise is activated, for example, by receiving a ‘POWER ON’ selection via a switch or button of the set-top box device or of a remote control device. Moving to block 402, the set-top box device transmits a prompt requesting a user profile selection to a display device coupled to the set-top box device. The set-top box device can generate the prompt or it can receive the prompt from a server of an Internet Protocol Television (IPTV) network. Continuing to block 404, the set-top box device can receive a user profile selection.

In a particular embodiment, the method proceeds to block 406, and the set-top box device can prompt the user to input a speed select function. Advancing to block 408, the set-top box device receives a selection of a speed select function. Continuing to block 410, the set-top box device can transmit a prompt for an authentication associated with the selected user profile to the display device. At decision step 412, the set-top box device can determine whether the password has been received. In an illustrative embodiment, if the authentication is not received, the method can move to block 414, and the set-top box device can communicate an instruction to a communication server or other server of the IPTV network that a default speed select function should be used to deliver calls. Conversely, if the authentication is received, the method advances to block 416, and the set-top box device can communicate the user profile selection and speed select function selection to the server. The method then terminates at 418.

In a particular embodiment, the steps of the methods described herein are executed in the order shown by the figures. In alternative embodiments, the steps may be executed in alternative sequences. For example, notifications of calls can be transmitted to activated set-top box devices before, or concurrently with, determinations of how calls are to be delivered.

Referring to FIG. 5, a diagram of an embodiment of a user interface to receive calls is shown at 500. The user interface 500 can be displayed at a display device, such as a television monitor 502. In the embodiment shown in FIG. 5, the user interface 500 includes a telephone call notification. The user interface 500 can overlay television content 508 and can contain multiple types of information. For example, the user interface 500 for the telephone call notification can include a caller or destination telephone number 504 and a telephone call symbol 506.

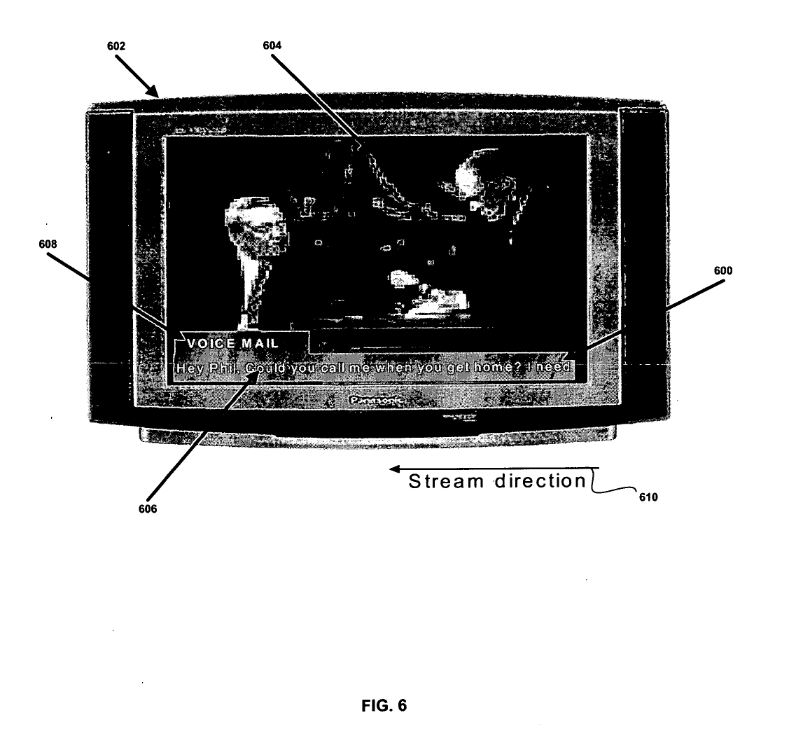

Referring to FIG. 6, a diagram of a second embodiment of a user interface to receive calls is shown. The user interface 600 can be provided on a television monitor 602. The user interface 600 can overlay a display region 604 that displays television content. In a particular embodiment, the user interface 600 can include a message content region 606 that displays content of a message, such as a text message converted from a voice mail message. In an illustrative embodiment, the content is displayed as streaming text that overlays the television content in the display region 604 and moves from right to left, as indicated by arrow 610.

The user interface 600 can include a tag region 608 that displays header information for each message displayed in the message content region 606. The tag region 608 can be appended to the message content region 606. In an illustrative embodiment, header information in the tag region 608 can include indicators of the type of message being displayed, e.g., ‘Voice Mail.’ In a particular embodiment, the television content displayed in the display region 604 continues uninterrupted, while the message content is displayed in the message content region 606 and while any header information is displayed in the tag region 608.

Referring to FIG. 7, an illustrative embodiment of a graphical user interface (GUI) to configure call delivery is illustrated and designated generally at 700. In a particular embodiment, the GUI 700 can be a handset location table that tracks rooms where IP phones are located. In another embodiment, the handset location table can also track other proximities covered by a phone, such as a phone with a wireless handset. The GUI 700 can include selectable indicators 702 of options to configure one or more set-top box devices. The GUI 700 can include one or more first editable fields in which a user can enter one or more handset names 704. In a particular embodiment, the GUI 700 can include one or more second editable fields in which a user can enter a Media Access Control (MAC) address 706 of each named handset configured via the GUI 700. The GUI 700 can also include one or more third editable fields in which a user can enter an Internet Protocol (IP) address 708 of each named handset configured via the GUI 700. Further, the GUI 700 can include one or more fourth editable fields in which a user can enter a static or dynamic type 710 of each IP address 708. For example, if the IP Phone was identified as “STATIC” then the system would expect the IP Address to remain unchanged and would not monitor the phone for an address change thus reducing the amount of traffic on the customer's network. Whereas, if the IP Phone was identified as a “DHCP” addressed phone then the system would need to check the IP Addressing associated to the MAC address on a regular time interval.

Referring to FIG. 8, a second illustrative embodiment of a graphical user interface (GUI) to configure call delivery is illustrated and designated generally at 800. The GUI 800 can include selectable indicators 802 of options to configure one or more user profiles. The GUI 800 can include one or more first editable fields in which a user can enter one or more user names 804 or other unique user identifiers. In a particular embodiment, the GUI 800 can include one or more second editable fields in which a user can enter a password 806 or other authentication token associated with each user profile configured via the GUI 800. In a particular embodiment, one or more of the second editable fields can contain no authentication token, for example, for children or other users that cannot or do not wish to remember a password. The GUI 800 can also include one or more third editable fields in which a user can enter additional access policies 808 associated with each user profile configured via the GUI 800.

Referring to FIG. 9, a third illustrative embodiment of a graphical user interface (GUI) to configure call delivery is illustrated and designated generally at 900. The GUI 900 can include a selectable indicator 902 to activate call delivery based on handset locations. In addition, the GUI can include selectable indicators 904 of options to associate one or more handset names with user profiles and set-top box devices. Further, the GUI 900 can include one or more first editable fields in which a user can enter one or more handset names 906. In a particular embodiment, the GUI 900 can include one or more second editable fields in which a user can enter one or more user profiles to be associated with the handset names. The GUI 900 can also include one or more third editable fields in which a user can enter unit numbers, IP addresses, or other identifiers of a set-top box device 908 that is to be associated with the handset names and user profiles.

Referring to FIG. 10, a fourth illustrative embodiment of a graphical user interface (GUI) to configure call delivery is illustrated and designated generally at 1000. The GUI 1000 can include a video content region 1002 in which video content is displayed. In addition, the GUI 1000 can include a prompt region 1004 that includes a first prompt 1006 requesting a user to select one of a plurality of user profiles 1008. Further, the prompt region 1004 can include a second prompt 1010 requesting a user to select one of a plurality of speed select functions 1012. User selections can be transmitted to a communication server of an IPTV network, for example, and can be used to deliver calls to various rooms in a customer premise, to forward calls, or to prompt the user with options for call delivery when each call is received.

In conjunction with the configuration of structure described herein, the system and method disclosed provide call delivery based on user presence at one or more set-top box devices of a customer premise. In a particular embodiment, a user can configure user profiles and speed select functions to be associated with various handsets at the customer premise. A communication server or other server of an Internet Protocol Television (IPTV) system can receive a call and associate the call with the customer premise. The server can determine whether one or more set-top box devices at the customer premise are activated and which user profiles have been selected at the activated set-top box devices. The server can deliver calls to phones inside and outside the proximities of activated set-top box devices, based on speed select functions associated with user profiles or selected upon activation of the activated set-top box devices. Alternatively, the server can forward calls or allow a user at an activated set-top box device to choose a speed select function when each call is received at the server. Further, the server can transmit notifications of each call to the activated set-top box devices.

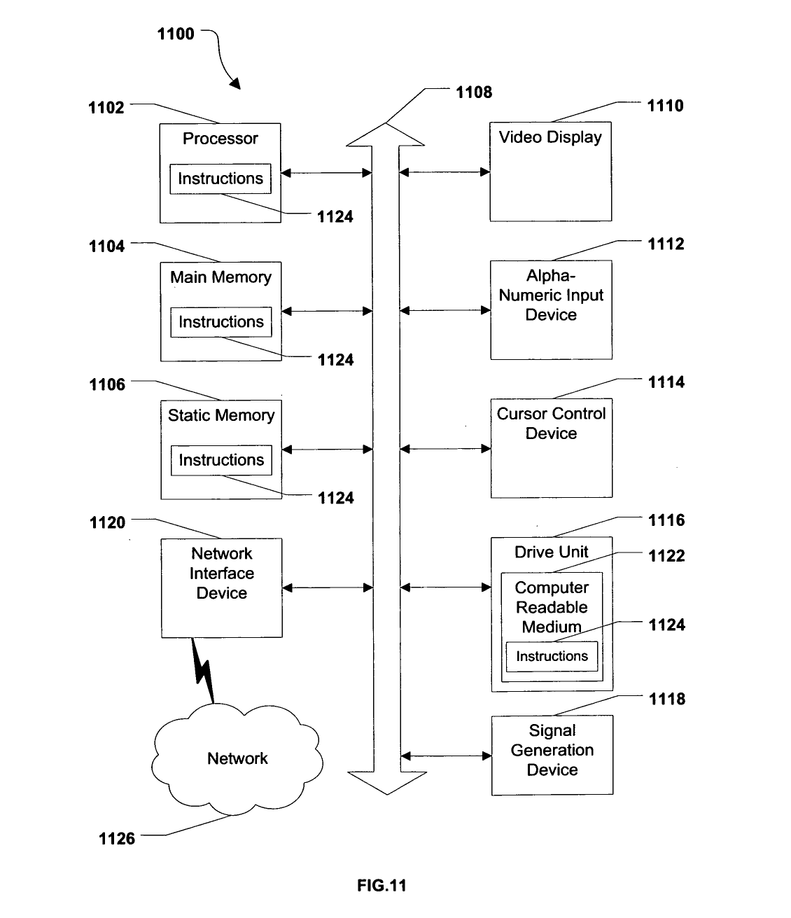

Referring to FIG. 11, an illustrative embodiment of a general computer system is shown and is designated 1100. The computer system 1100 can include a set of instructions that can be executed to cause the computer system 1100 to perform any one or more of the methods or computer based functions disclosed herein. The computer system 1100, or any portion thereof, may operate as a standalone device or may be connected, e.g., using a network, to other computer systems or peripheral devices, including a server or set-top box device, as shown in FIG. 1.

In a networked deployment, the computer system may operate in the capacity of an IPTV server or set-top box device. The computer system 1100 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1100 can be implemented using electronic devices that provide voice, video or data communication. Further, while a single computer system 1100 is illustrated, the term “system” shall also be taken to include any collection of systems or sub-systems that individually or jointly execute a set, or multiple sets, of instructions to perform one or more computer functions.

As illustrated in FIG. 11, the computer system 1100 may include a processor 1102, e.g., a central processing unit (CPU), a graphics-processing unit (GPU), or both. Moreover, the computer system 1100 can include a main memory 1104 and a static memory 1106 that can communicate with each other via a bus 1108. As shown, the computer system 1100 may further include a video display unit 1110, such as a liquid crystal display (LCD), an organic light emitting diode (OLED), a flat panel display, a solid state display, or a cathode ray tube (CRT). Additionally, the computer system 1100 may include an input device 1112, such as a keyboard, and a cursor control device 1114, such as a mouse. Further, the computer system 1100 can include a wireless input device 1115, e.g., a remote control device. The computer system 1100 can also include a disk drive unit 1116, a signal generation device 1118, such as a speaker or remote control, and a network interface device 1120.

In a particular embodiment, as depicted in FIG. 11, the disk drive unit 1116 may include a computer-readable medium 1122 in which one or more sets of instructions 1124, e.g. software, can be embedded. Further, the instructions 1124 may embody one or more of the methods or logic as described herein. In a particular embodiment, the instructions 1124 may reside completely, or at least partially, within the main memory 1104, the static memory 1106, and/or within the processor 1102 during execution by the computer system 1100. The main memory 1104 and the processor 1102 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 1124 or receives and executes instructions 1124 responsive to a propagated signal, so that a device connected to a network 1126 can communicate voice, video or data over the network 1126. Further, the instructions 1124 may be transmitted or received over the network 1126 via the network interface device 1120.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of delivering calls, the method comprising:
receiving a call at a server within an Internet Protocol Television (IPTV) system, wherein the call is directed to a user premise;
determining a presence of a user at a set-top box device at the user premise;
determining a speed select function associated with the user; and
selectively delivering the call to a communication device in proximity to the set-top box device via a private access network of the IPTV system, based on the speed select function.

2. The method of claim 1, further comprising:
associating a user account with a destination address of the call; and
determining that the call is directed to the user premise at the destination address.

3. The method of claim 1, further comprising determining that the set-top box device is activated.

4. The method of claim 3, further comprising associating the user account with at least one identifier of the set-top box device, wherein the at least one identifier includes an Internet Protocol (IP) address of the set-top box device, data associated with at least one communication line coupled to the set-top box device, an alphanumeric identifier of the set-top box device, or any combination thereof.

5. The method of claim 3, further comprising receiving a selection of a user profile when the set-top box is activated.

6. The method of claim 5, further comprising receiving a selection of the speed select function when the set-top box is activated.

7. The method of claim 1, further comprising:
determining that no set-top box device is activated at the user premise; and
delivering the call to multiple phones at the user premise.

8. The method of claim 1, further comprising delivering the call to a selected phone in a room of the set-top box device, wherein the speed select function indicates that the selected phone is enabled.

9. The method of claim 8, further comprising instructing the set-top box device to lower a volume of audio associated with video content transmitted to a display device.

10. The method of claim 1, further comprising delivering the call to at least one other phone at the user premise, wherein the at least one other phone is not located in a room of the set-top box device.

11. The method of claim 1, further comprising forwarding the call to a forwarding destination, wherein the speed select function indicates that the call is to be forwarded.

12. The method of claim 11, wherein the forwarding destination is a voice mail system.

13. The method of claim 11, wherein the forwarding destination is a cellular phone.

14. The method of claim 1, further comprising transmitting a notification of the call to the set-top box device.

15. The method of claim 14, further comprising obtaining caller identification (caller ID) information corresponding to a source of the call and wherein the notification comprises the caller ID information.

16. A method of receiving calls, the method comprising:
prompting a user to input a selection of a user profile during activation of a set-top box device; and
communicating the user profile to a server of an Internet Protocol Television (IPTV) system, wherein the server selectively delivers calls to a phone in proximity to the set-top box device based on a speed select function associated with the user profile.

17. The method of claim 16, further comprising prompting the user to input the speed select function when the set-top box device is activated.

18. The method of claim 16, wherein the user configures the user profile at the server via the set-top box device.

19. The method of claim 18, further comprising prompting the user to input an authentication token before communicating the user profile to the server, wherein the authentication token is associated with the user profile.

20. The method of claim 18, wherein the speed select function is associated with the user profile.

21. The method of claim 18, wherein the user profile is associated with the phone, the set-top box device, or any combination thereof.

22. The method of claim 16, further comprising:
receiving an options user interface from the server when the speed select function indicates that the user is to be prompted with a plurality of options;
receiving a selection of a second speed select function; and
communicating the selection of the second speed select function to the server, wherein the server selectively delivers the calls to the phone in proximity to the set-top box device based on the second speed select function.

23. A system to deliver calls, the system comprising:
a communication server within an Internet Protocol Television (IPTV) system, wherein the communication server is configured to receive a call;
wherein the communication server is configured to determine a presence of a user at a set-top box device at a user premise and to determine a speed select function associated with the user; and
wherein the communication server is configured to selectively deliver the call to a phone in proximity to the set-top box device based on the speed select function.

24. The system of claim 23, wherein the communication server is configured to determine whether the call is answered and to prompt a caller to input a voice mail message when the call is not answered.

25. The system of claim 24, wherein the communication server stores the voice mail message.

26. The system of claim 24, wherein the communication server is configured to transmit a notification of the voice mail message to the set-top box device.

27. The system of claim 26, wherein the communication server is configured to transmit the voice mail message to the set-top box device in response to a request from the set-top box device.

28. The system of claim 27, wherein the communication server is configured to convert the voice mail message to a text message and to transmit the text message to the set-top box device.

29. A computer program embedded in a computer-readable medium, the computer program comprising:
instructions to communicate with at least one communication network to receive a call directed to a user premise;
instructions to determine a presence of a user at a set-top box device at the user premise and to determine a speed select function associated with the user; and
instructions to selectively deliver the call to a communication device in proximity to the set-top box device based on the speed select function.

30. The computer program of claim 29, further comprising:
instructions to determine the presence of a second user at a second set-top box device at the user premise and to determine a second speed select function associated with the second user; and
instructions to selectively deliver the call to a second phone in proximity to the second set-top box device based on the second speed select function.

31. The computer program of claim 30, wherein the phone and the second phone are Internet Protocol (IP) phones.

32. The computer program of claim 31, wherein at least one of the IP phones includes a wireless handset and is associated with a plurality of rooms of the user premise.

33. The computer program of claim 29, wherein the speed select function includes a call delivery rule.

34. The computer program of claim 29, wherein the user is logged in at the set-top box device.
